(19) United States
(12) Patent Application Publication
(10) Pub. No.: US 2024/0198770 A1
(43) Pub. Date: Jun. 20, 2024

(54) Openable Vehicle Roof Comprising a Cover

(71) Applicant: Webasto SE, Stockdorf (DE)

(72) Inventor: Rudolf DIETL, Stockdorf (DE)

(21) Appl. No.: 18/539,649

(22) Filed: Dec. 14, 2023

(30) Foreign Application Priority Data
Dec. 19, 2022 (DE) 10 2022 133 954.8

(51) Int. Cl. B60J 7/043; B60J 7/057

(52) U.S. Cl. CPC B60J 7/0435; B60J 7/0573

(57) ABSTRACT

A vehicle roof with a cover closing a roof opening, having comprising a bearing device which movably bears the cover by a front bearing unit and by a rear bearing unit on a longitudinal guide, located on the roof side, and adjusts the cover between a closed position in the roof opening and at least one ventilation position deployed upwards on its rear edge, and having a cover adjusting drive which is assigned to the front bearing unit and which actuates the rear bearing unit by a control element, wherein the control element is longitudinally displaceably mounted on a longitudinal guide arranged on the cover.

### CROSS-REFERENCE TO RELATED APPLICATION

This application claims priority from German Patent Application Number 10 2022 133 954.8, filed on Dec. 19, 2022, which is hereby incorporated herein by reference in its entirety for all purposes.

### FIELD

The invention relates to a vehicle roof comprising a cover closing a roof opening, comprising a bearing device which movably bears the cover by means of a front bearing unit and a rear bearing unit on a longitudinal guide, located on the roof side, and adjusts the cover between a closed position in the roof opening and at least one ventilation position deployed upwards on its rear edge, and comprising a cover adjusting drive which is assigned to the front bearing unit and which actuates the rear bearing unit by means of a control element.

### BACKGROUND

An openable vehicle roof of the type in question comprising a cover has been disclosed in DE 10 2013 013 587 A1. A bearing device movably bears the cover on a longitudinal guide, located on the roof side, by means of a front bearing unit and a rear bearing unit. The cover is adjustable between a closed position in a roof opening and at least one ventilation position deployed upwards on its rear edge. A coupling device couples the rear bearing unit to a drive carriage which is displaceably arranged on the longitudinal guide. The coupling device contains a coupling rod which is arranged in the region of the longitudinal guide, located on the roof side.

### SUMMARY

The object of the invention is to provide a vehicle roof of the type mentioned in the introduction which is improved regarding an activation of the rear bearing device by a cover adjusting drive.

This object is achieved in the vehicle roof according to the invention, which is mentioned in the introduction, by the control element being longitudinally displaceably mounted on a longitudinal guide arranged on the cover.

Advantageous embodiments of the invention are specified in the dependent claims.

In the vehicle roof according to the invention, therefore, the control element is arranged in a manner which saves constructional space due to the bearing thereof on the lower face of the cover and in the vicinity of the cover. The control element moves when the rear bearing unit is actuated and adjusted relative to the cover. When the adjusting actuation is completed, the control element is arranged so as to rest on the cover and moves together with the cover while it is being displaced, for example, into an open position.

Preferably, the elongated control element is received so as to be guided in the longitudinal guide over the guide length of the longitudinal guide. The control element is thus not only guided at its two ends but substantially over its entire length. Thus it is prevented that the control element is able to be set into vibration, for example, during operation. Such vibrations can occur in the case of an elongated control element which is mounted and guided merely at its two ends, and otherwise is freely movable between its ends in the transverse direction and can be set into vibration. Moreover, the control element is prevented from bulging or buckling. The control element thus can be formed with a relatively small cross section.

According to a preferred embodiment, it is provided that the longitudinal guide is formed as a guide channel in which the elongated control element is displaceably received. Such a guide channel can have, for example, a substantially rectangular cross section and, in particular, is cylindrically formed.

Preferably, the elongated control element is a control rod or a cable which is rigid in terms of tension and compression. The longitudinal guide, in particular as a cylindrical guide channel, permits the use of such a cable which is rigid in terms of tension and compression.

Expediently, the longitudinal guide, located on the cover side, and on which or in which the control element is mounted and guided, is formed on a cover rail. The cover rail is arranged, for example as an aluminum extruded profile, on the cover lower face and, in particular, is attached to a cover frame or to a cover plate. The cover frame or the cover plate is expediently fastened to the cover lower face by means of a polyurethane foam. The cover rail is attached, for example, by means of a screw connection and preferably in an adjustable manner to the cover frame or to the cover plate, but can also be fastened thereto by rivets or by adhesive. On the other hand, the cover rail can also be an integral part of the cover frame or the cover plate.

The longitudinal guide, located on the cover side, is preferably substantially or entirely surrounded by the cover rail over the entire guide length, so that the control element is enclosed therein. The control element is thus a cable which is rigid in terms of tension and compression, for example, as is known as the drive cable of the cover adjusting drive. The control element can also be a control rod, or the like, which is guided over its entire length on or in the cover rail, or which is guided only at guide points which are spaced apart from one another and which form the longitudinal guide.

Expediently, the longitudinal guide which is arranged on the cover or the cover rail is arranged substantially vertically over the front longitudinal guide. As a result, a compact arrangement of the control element is achieved relative to the longitudinal guide, located on the roof side.

According to a preferred embodiment, it is provided that the longitudinal guide, located on the roof side, has a front longitudinal guide with the front bearing unit mounted thereon and a rear longitudinal guide with the rear bearing unit mounted thereon. These two longitudinal guides are expediently arranged on a roof frame. Such a roof frame is expediently a load-bearing part of the roof structural unit which bears the cover and which is fastened via this roof frame to the vehicle roof. Preferably, the front longitudinal guide is arranged in a dry area of the roof frame and the rear longitudinal guide is arranged in a wet area of the roof frame. Generally, the dry area is separated from the wet area by means of a partition wall, or the like. In DE 10 2013 013 587 A1 a controlling coupling rod is guided through an opening in the partition wall. This design requires the moving coupling rod to be sealed relative to the partition wall. Accordingly, in the arrangement of the control element on the cover according to the invention, such a through-passage through a partition wall and also a seal required therefor are dispensed with.

According to a particularly preferred embodiment, it is provided that the cover is mounted on the front longitudinal guide, on the rear longitudinal guide and on the longitudinal guide located on the cover side, in each case via slides on two guide components or guides which are assigned to one another and which are arranged adjacent to one another in the cover transverse direction. Such a duplicated or double-shear slide guide is suitable for supporting a cover which has a higher weight, in comparison with the known bearings and supports which have in each case only one slide on a guide. In particular, the duplicated or double-shear slide guide is provided in every position of the cover and continuously over the entire adjustment path of the cover.

According to a further preferred embodiment, it is provided that the cover adjusting drive has a drive carriage which is displaceably mounted on the longitudinal guide, located on the roof side, or on a guide rail of the front longitudinal guide. The drive carriage is coupled to the control element by means of a coupling unit. The coupling unit contains, for example, components which are coupled via joints and which ensure an adaptation of the moved cover to the longitudinally guided drive carriage. Such mechanical components provide a stable coupling between the drive carriage and the control element.

Expediently, the control element is connected in the region of its front end to a control element slide which is displaceably mounted on the cover rail and via which the coupling unit is coupled to the control element. The control element slide is thus preferably arranged in the region of the drive carriage in a longitudinal guide of the cover rail adjacent to the longitudinal guide of the control element. The longitudinal guide expediently has a longitudinal slot, or the like, through which a coupling component which is connected to the control element slide extends.

Preferably, the coupling unit contains a coupling link which, on the one hand, is pivotably articulated to the drive carriage and, on the other hand, is pivotably connected to a driver element which is fixedly connected to the control element slide. The driver element is, for example, formed in a U-shape with two arms. The one arm is fixedly connected to the control element slide, while the coupling link is articulated to the other arm. The driver element is guided on the cover rail on a movement and guide track which is defined in both movement directions by stops.

Expediently, the rear bearing unit comprises a deployment lever which is coupled to a cover carriage of the rear bearing unit. The cover carriage is displaceably mounted on a carriage guide, located on the cover side, and is connected to the control element. The carriage guide, located on the cover side, can be a separate guide component which has two guides and which is fastened to the cover frame or is formed thereon.

According to a preferred embodiment, it is provided that the carriage guide, located on the cover side, has the cover rail and an additional cover rail which is arranged parallel to a rear portion of the cover rail. The cover carriage is displaceably mounted on the cover rail and on the additional cover rail on its two opposing longitudinal sides in the cover transverse direction.

Preferably, the deployment lever of the rear bearing unit is displaceably mounted on two opposing guide tracks of the carriage guide, located on the roof side, by means of assigned carriage slides. A cover having a higher cover weight can be securely supported by means of this duplicated bearing.

In a preferred embodiment, it is provided that a guide rail of the front longitudinal guide, located on the roof side, has on its front end an inner lifting slotted track and an outer lifting slotted track relative to the cover transverse direction. The front bearing unit contains a front cover support arm which is slidably supported by means of slides on the two sides, both on the inner lifting slotted track and on the outer lifting slotted track. The path of the rising lifting slotted tracks controls the movement of the cover in the region of its cover front edge.

Expediently, the front cover support arm contains a control engagement part which is received in a control slotted track of the drive carriage. The control slotted track has differently running portions. If the control engagement part is received in a vertical portion of the control slotted track, the moving drive carriage displaces the cover via the control engagement part in the longitudinal direction along the front longitudinal guide. In the event of a front collision, the cover, in particular when it is in an open position, is secured against an abrupt forward movement via the control engagement part received in the vertical portion. The coupling link of the coupling unit also secures the cover in the event of a crash due to its support of the driver element, which in turn strikes against the cover rail at the end of its movement path.

Expediently, in the vehicle roof according to the invention it is provided that in the closed position of the cover the drive carriage and the control element coupled thereto are arranged in respective front positions. With an adjustment of the cover into its ventilation position, the longitudinally moved drive carriage displaces the control element to the rear and therewith the cover carriage relative to the cover which is substantially fixedly held in the longitudinal direction. The cover carriage over its relative displacement displaces the deployment lever which is arranged on a front lifting portion of the rear longitudinal guide, located on the roof side, into its deployed position.

Preferably, the length of the additional cover rail corresponds to the adjustment path of the cover carriage on the cover. Accordingly, the additional cover rail has to be provided only at such a length as is required for the adjusting movement of the cover carriage.

The vehicle roof according to the invention thus has a control element in an improved and protected arrangement and bearing on the cover lower face. Moreover, the cover is always securely supported on the front bearing unit and on the rear bearing unit via at least one slide pair arranged in the transverse direction on two assigned guides of the longitudinal guides.

### BRIEF DESCRIPTIONS OF THE DRAWINGS

The invention is explained in more detail hereinafter by way of an exemplary embodiment of a vehicle roof according to the invention with reference to the drawing.

In the drawing:

FIG. 1 shows in a perspective plan view a vehicle with an openable vehicle roof and with a cover in the closed position;

FIG. 2 shows in a perspective plan view the vehicle roof of FIG. 1 with the cover open;

FIG. 3 shows in a partial isometric view a roof frame with a front longitudinal guide and a rear longitudinal guide of a bearing device of the cover;

FIG. 4 shows in an isometric view the front and the rear longitudinal guide with a front bearing unit and with a rear bearing unit;

FIG. 5 shows in an isometric view a cover frame of the cover with a cover rail and a rear additional cover rail for the rear bearing unit;

FIG. 6 shows in a exploded view the front bearing unit of the cover;

FIG. 7 shows in an exploded view the rear bearing unit of the cover;

FIG. 8 shows in a cross-sectional view along the cutting line A-A in FIG. 12 a front guide rail of the front longitudinal guide and a drive carriage mounted thereon;

FIG. 9 shows in a cross-sectional view along the cutting line B-B in FIG. 12 the front guide rail with the drive carriage and with parts of a coupling device;

FIG. 10 shows in a cross-sectional view along the cutting line C-C in FIG. 12 the front guide rail with the drive carriage and further parts of the coupling device;

FIG. 11 shows in an isometric view the front bearing unit in a position with the cover closed;

FIG. 12 shows in a side view the front bearing unit with the cover closed;

FIG. 13 shows in an isometric view the rear bearing unit with the cover closed;

FIG. 14 shows in a side view the front bearing unit in a position with the cover pivoted out into a ventilation position;

FIG. 15 shows in an isometric view the rear bearing unit with the cover position according to FIG. 14;

FIG. 16 shows in an isometric view the front bearing unit in a position in which it has fully lifted the cover;

FIG. 17 shows in a side view the front bearing unit in the position of FIG. 16 at the start of a longitudinal displacement of the cover;

FIG. 18 shows in an isometric view the rear bearing unit with the cover position according to FIG. 17;

FIG. 19 shows in an isometric view the front bearing unit with the cover closed;

FIG. 20 shows in an isometric view the front bearing unit with the cover pivoted out on its rear edge;

FIG. 21 shows in an isometric view the front bearing unit in a position according to FIG. 17;

FIG. 22 shows in a cross-sectional view along the cutting line D-D in FIG. 13 the front guide rail and the rear guide rail in the region of the rear bearing unit with the cover closed;

FIG. 23 shows in a cross-sectional view along the cutting line E-E in FIG. 24 the front guide rail and the rear guide rail in the region of the rear bearing unit with the cover closed; and

FIG. 24 shows in a plan view the rear bearing unit with the cover closed.

### DETAILED DESCRIPTION

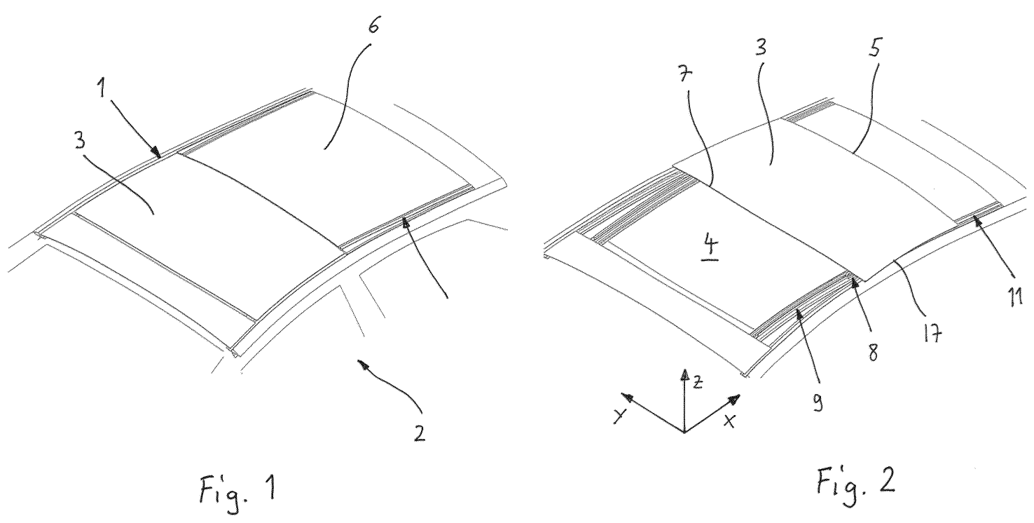

An openable vehicle roof 1 of a vehicle 2, such as for example a passenger motor vehicle, has a cover 3 (see FIGS. 1 and 2) which can be lifted from a closed position in a roof opening 4 and can be adjusted into a ventilation position, and can be moved from the ventilation position with the lifted cover rear edge 5 over an adjoining roof portion 6 in the vehicle or roof longitudinal direction to the rear of the roof opening 4 into an open position (position according to FIG. 2). Such a roof is in principle an externally guided sliding roof or spoiler roof. The rear roof portion 6 can be formed from a fixed roof or even from a movable roof part. The axial and directional terms used in the description, such as for example “front” and “rear”, “above” and “below”, “outer” and “inner”, “horizontal” and “vertical” and “lateral”, in the transverse direction and longitudinal direction refer to a three-dimensional x-y-z vehicle coordinate system.

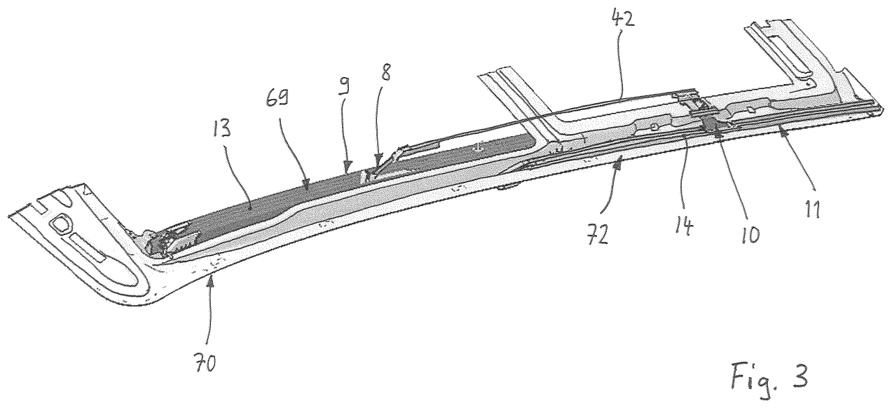

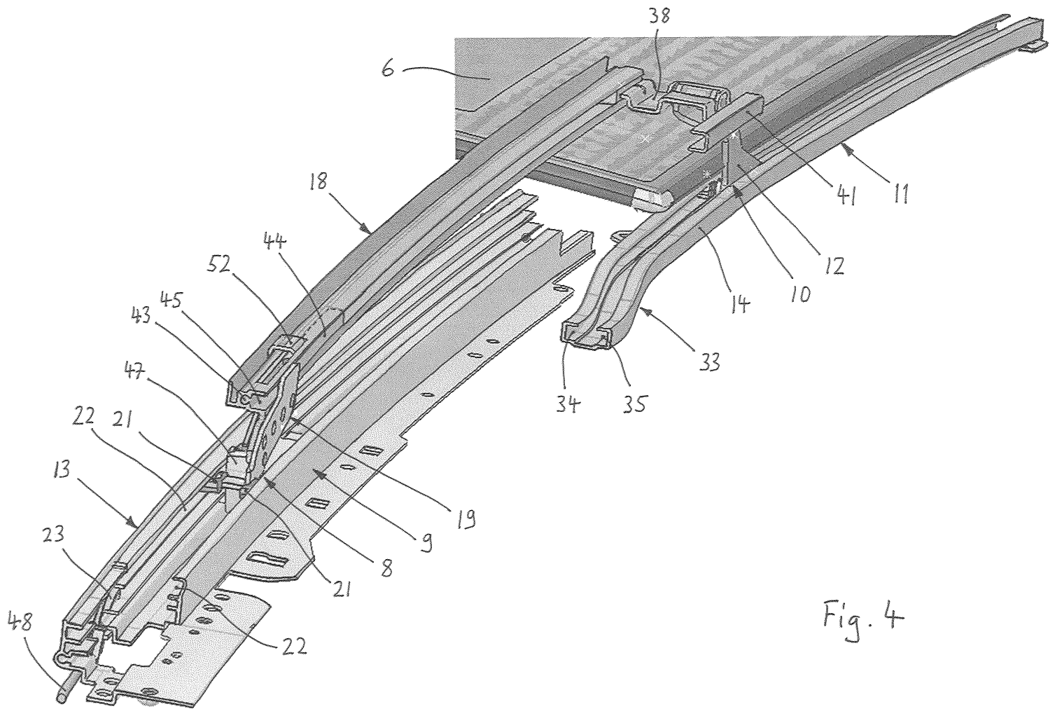

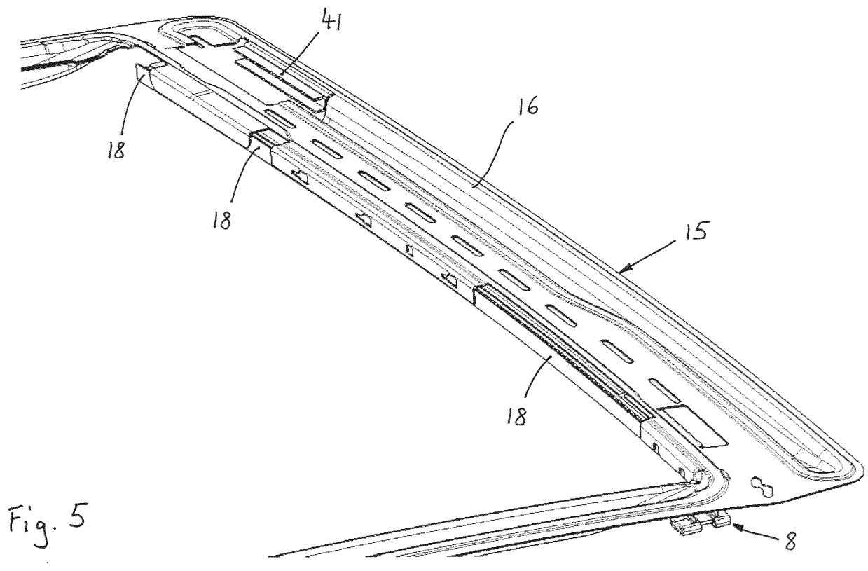

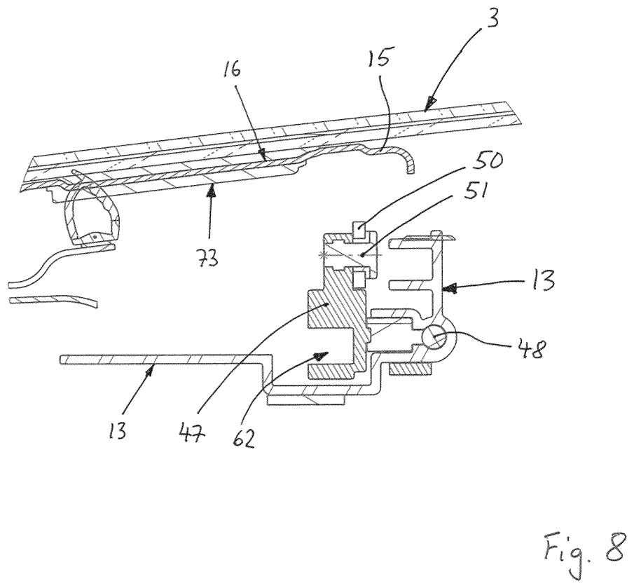

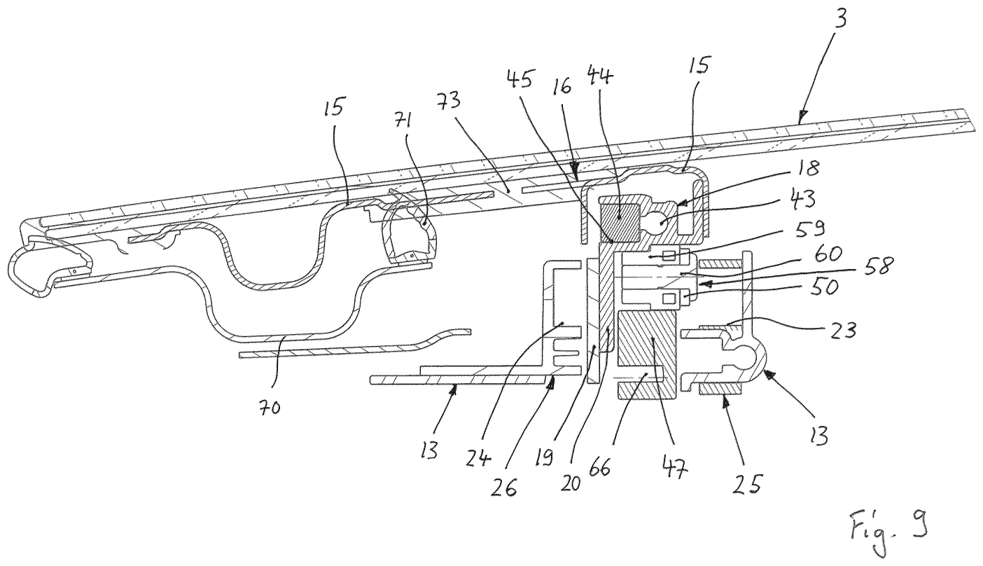

A bearing device for the cover 3 is designed such that the cover 3 is movably mounted on both sides of the roof opening 4 in each case by means of a front bearing unit 8, which is arranged for example in the region of the cover front edge 7, along a lateral front longitudinal guide 9, and by means of a rear bearing unit 10 relative to the cover 3, along a rear longitudinal guide 11. The front longitudinal guide 9 and the rear longitudinal guide 11 are arranged on the vehicle roof 1 and expediently on a roof frame 70 (FIG. 3) of a roof structural unit attached to the vehicle roof 1 and movably bearing the cover 3. The rear bearing unit 10 has a deployment lever 12 (FIGS. 4 and 7) by which the cover 3 can be pivoted out on its rear edge 5 into its ventilation and spoiler position. The front longitudinal guide 9 and the rear longitudinal guide 11 are preferably arranged in each case on separate guide rails 13 or 14 or formed thereon. The roof structure and a roof structural unit, or the sliding or spoiler roof structural unit, containing the cover 3 and the bearing units 8 and 10 and the longitudinal guides 9 and 11, is substantially symmetrical to a vertical longitudinal central plane of the vehicle roof 1 so that the following description is made on the basis of the components and bearing units 8 and 10 arranged on the left-hand longitudinal side of the vehicle roof 1 or the roof opening 4.

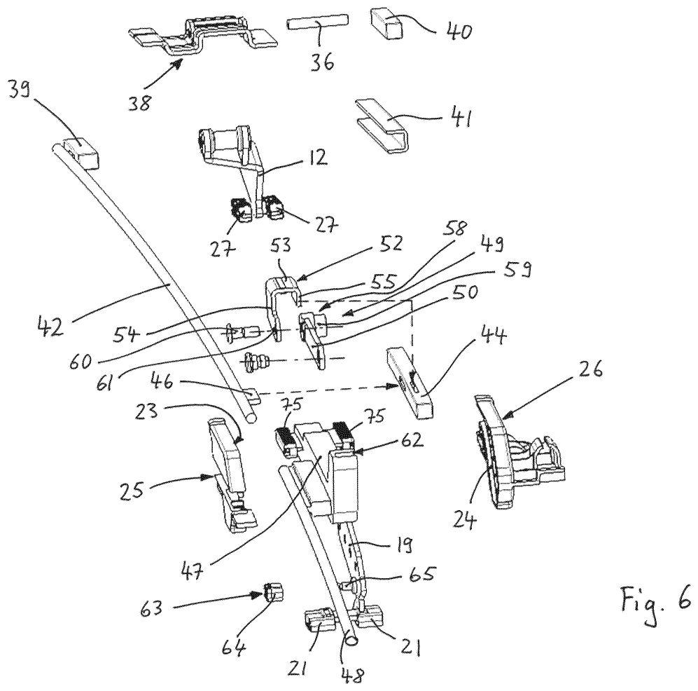

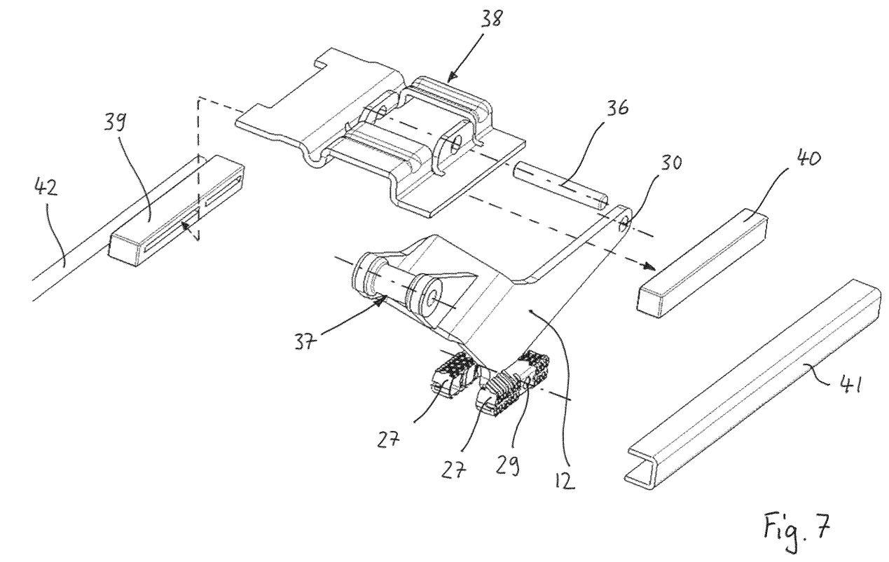

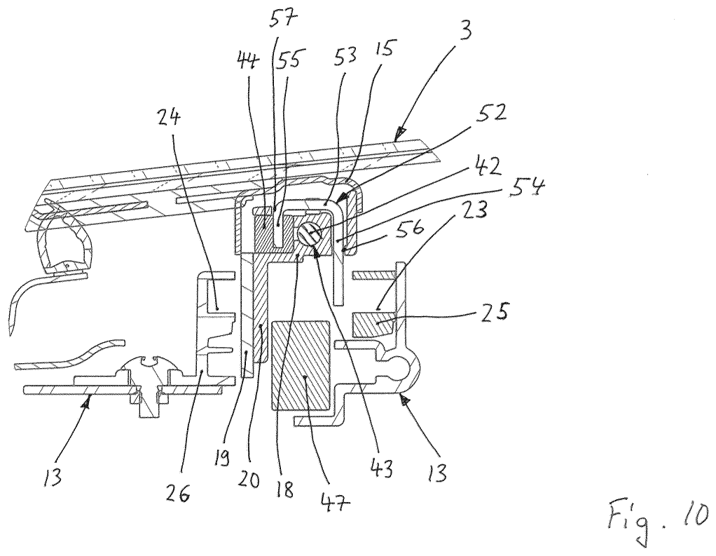

The cover 3 has a cover frame 15 (FIG. 5) which is formed, for example, by a cover internal plate and is fastened to the cover lower face, for example by means of a PUR foam 73 (FIG. 9). The cover frame 15 contains in each case a lateral frame longitudinal portion 16 which is arranged inwardly of the side edge 17 of the cover 3. A cover rail 18, for example an aluminum profile rail, is fastened on the lower face of the frame longitudinal portion 16 and in the cover transverse direction on the inner face to the frame longitudinal portion 16 such that when the cover 3 is closed it is located lengthways or in the longitudinal direction substantially over the guide rail 13, located on the roof side. The cover rail 18 forming a cover support has on its front end a cover support arm 19 (FIGS. 4 and 6) which is fastened to a flange 20 of the cover rail 18 and protrudes downwardly. The cover support arm 19 contains on its lower or front end two opposing slides 21 in the transverse direction. The guide rail 13 comprises two groove-shaped and opposing slide guides 22 which are assigned to the slides 21 and on which the two slides 21 are displaceably guided. An inner lifting slotted track 23 and an outer lifting slotted track 24 form front portions of the two slide guides 22 which rise in a curved manner. The two lifting slotted tracks 23 and 24 are preferably formed on an inner slotted track component 25 and on an outer slotted track component 26 which are attached to the front end of the guide rail 13. When the cover 3 is closed, the slides 21 are arranged in the lowered position on the front or lower end of the two lifting slotted tracks 23, 24 (FIG. 12).

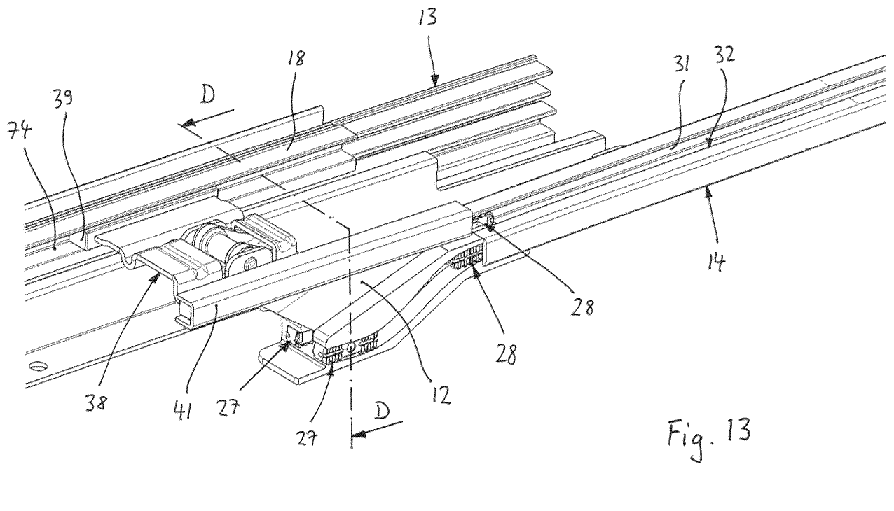

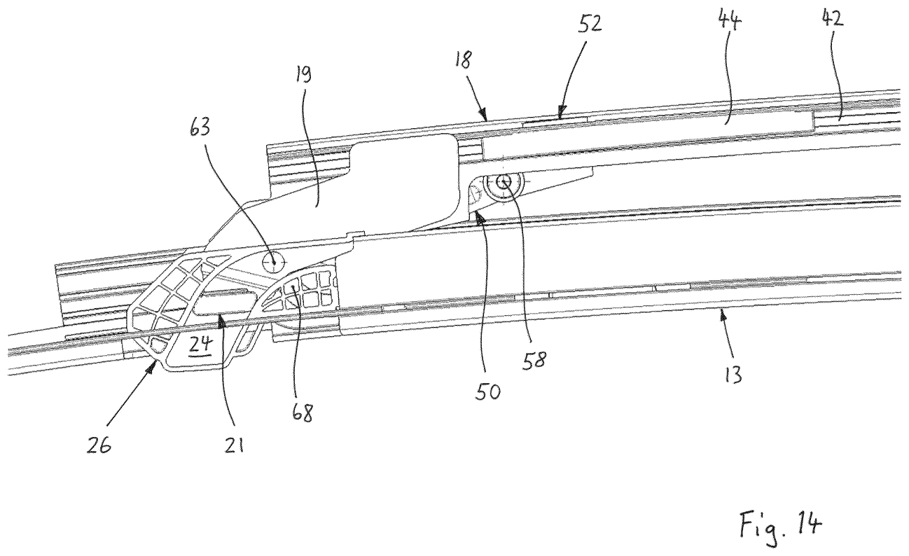

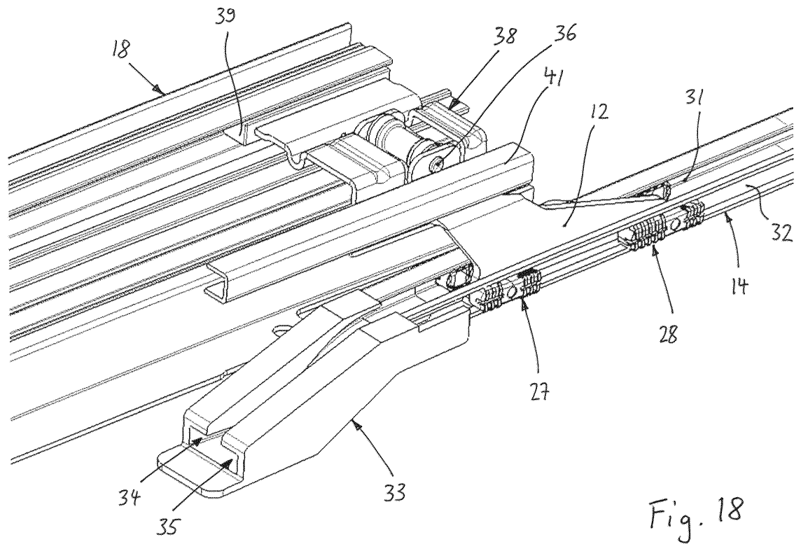

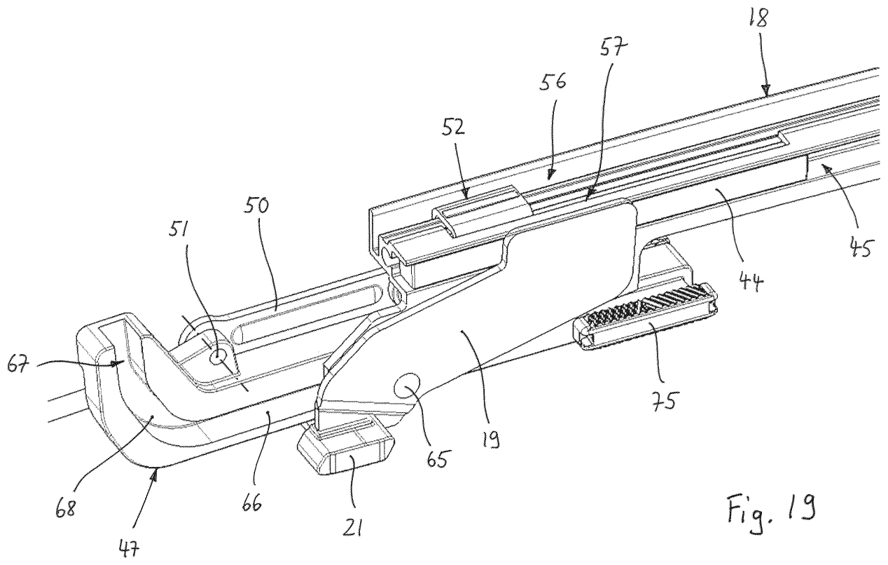

The deployment lever 12 of the rear bearing unit 10 has two opposing front slides 27 and two opposing rear slides 28 which in each case are pivotably mounted by means of a front bearing axis 29 and a rear bearing axis 30 on the lower edge of the deployment lever 12. The rear guide rail 14 has two opposing slide tracks 31 and 32 in which the inner or outer slides of the front slides 27 and the rear slides 28 are respectively displaceably received. The rear guide rail 14 has on its front end a lifting portion 33 with two opposing lifting slotted tracks 34 and 35 which lift the two front slides 27 from a lower position, when the cover 3 (FIG. 13) is closed, to the higher level of the slide tracks 31 and 32 (FIG. 18) and at the same time pivot and deploy the deployment lever 12.

The deployment lever 12 at its end located on the cover side is pivotably mounted on a cover carriage 38 by means of a pivot bearing 37 (FIG. 7) having a bearing pin 36. The cover carriage 38 is displaceably mounted, on the one hand, via an inner carriage slide 39 on a carriage guide 74 (FIG. 22) of the cover rail 18 and, on the other hand, via an outer carriage slide 40 on a carriage guide of an outer additional cover rail 41, which is fastened parallel to a rear portion of the cover rail 18 on the lateral frame longitudinal portion 16 of the cover frame 15 (FIGS. 5 and 22), for example by means of a screw connection.

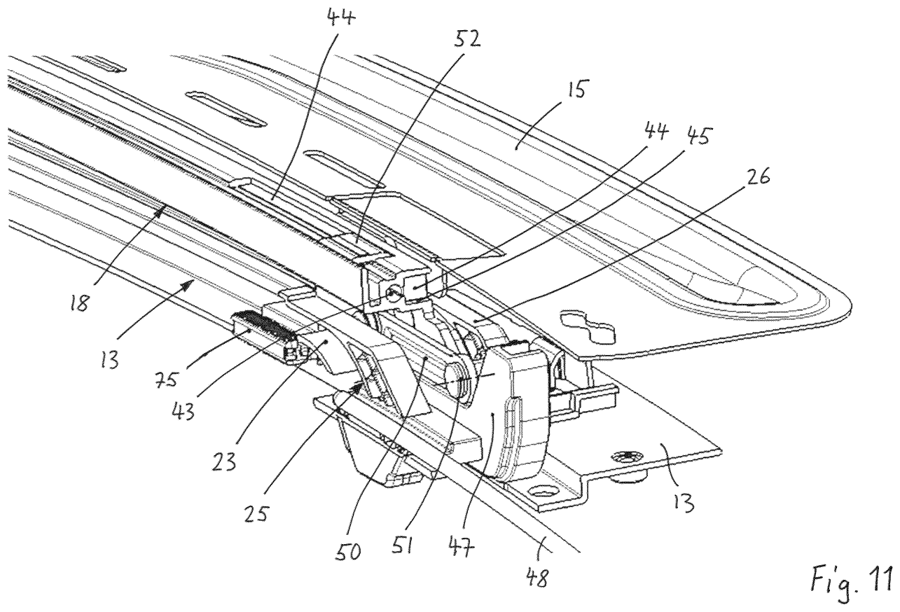

An elongated control element 42 (FIGS. 6 and 10) is displaceably received in a longitudinal guide 43 which is arranged, for example, on the cover rail 18 or formed thereon. The longitudinal guide 43 comprises, for example, a cylindrical guide channel in which a control rod or a drive cable, which is rigid in terms of compression, is received as the control element 42. The control element 42 is connected at its rear end to the inner carriage slide 39. For example, the control element 42 at its rear end contains a lateral projection or the like, to which the inner carriage slide 39 is fastened or is formed as an overmolded portion. The control element 42 extends over the length of the cover rail 18 and in the region of its front end is connected to a control element slide 44 which is displaceably received in a slide guide 45 (FIG. 9) of the cover rail 18 adjacent to the control element 42. The control element slide 44 is positioned, for example, on a lateral projection 46 of the control element 42.

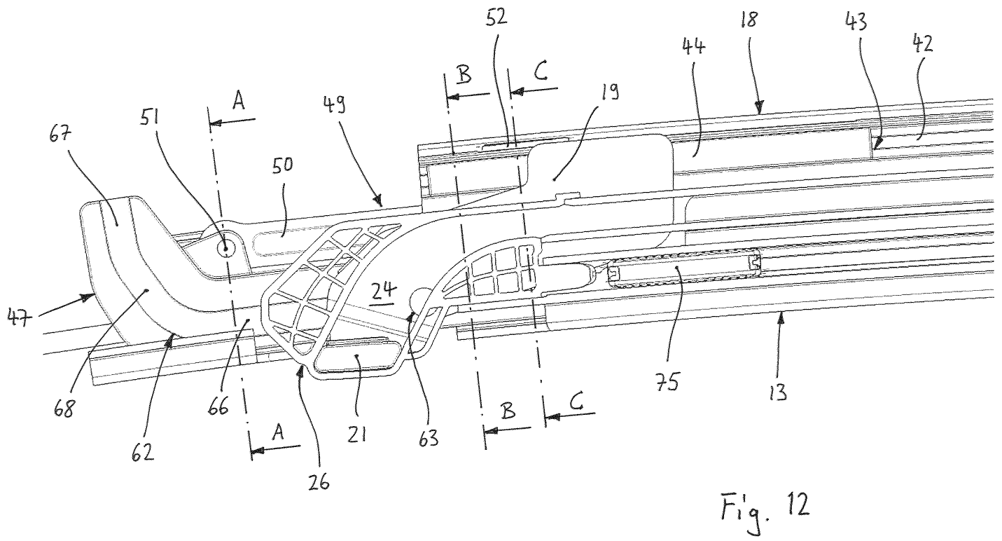

A drive carriage 47 (FIGS. 11 and 12) of the cover adjusting drive is displaceably mounted on the front guide rail 13 by means of slides 75 and connected to a drive cable 48 which is guided in a cable guide to a drive motor (not shown) which is centrally located, for example, on a roof frame of the vehicle roof 1 in front of the roof opening 4. The drive carriage 47 is connected by means of a coupling unit 49 to the control element slide 44 (FIG. 6). The coupling unit 49 has a coupling link 50 which is pivotably articulated, on the one hand, to the drive carriage 47 by means of a pivot bearing 51 and, on the other hand, is pivotably connected to a driver element 52 which is arranged on the cover rail 18. The driver element 52 is U-shaped in cross section and has a base 53 and an inner arm 54 and an outer arm 55 (FIG. 10). The driver element 52 encompasses with its base 53 the region of the cover rail 18 which contains the longitudinal guide 43 of the control element 18. The inner arm 54 protrudes downwardly through an inner longitudinal slot 56 formed in the cover rail 18. The outer arm 55 protrudes downwardly through an outer longitudinal slot 57 which is formed on the upper face of the slide guide 45 of the cover rail 18, and is fixedly inserted from above into the control element slide 44.

The coupling link 50 is connected by means of a pivot joint 58 to the driver element 52 via the inner arm 54 thereof (FIGS. 6 and 9). The pivot joint 58 comprises a bearing bush 59 which, for example, is attached as an injection-molded part to the end of the coupling link 50, and a bearing pin 60 which is inserted through a bearing opening 61 in the inner arm 54 of the driver element 52 and, for example, pressed or screwed into the bearing bush 59.

The drive carriage 47 has a control slotted track 62 (FIGS. 6 and 12) which is open laterally outwardly toward the cover support arm 19. A control engagement part 63, which protrudes inwardly toward the drive carriage 47 and is received in the control slotted track 62, is attached to the cover support arm 19. The control engagement part 63 is, for example, a rotating slide 64 which is mounted on a bearing pin 65 which is fixedly attached to the cover support arm 19. The control slotted track 62 has a horizontal portion 66, which runs parallel to the front guide rail 13, a front vertical portion 67 and a transition portion 68 which forms a guide transition which runs in a curved manner from the horizontal portion 66 to the front vertical portion 67.

The front guide rail 13 is arranged in a dry area 69 of the vehicle roof 1 or the roof frame 70 (see FIGS. 3 and 22) which extends inside a cover seal 71 which seals the cover 3 relative to the roof frame 70 and is fastened to the roof frame 70. The front bearing unit 8 moves together with the drive carriage 47 in this dry area 69.

The rear guide rail 14 is arranged in a wet area 72 which is separate from the dry area 69. The rear deployment lever 12 of the rear bearing unit 10 moves along the rear guide rail 14 in the wet area 72 when the cover 3 is displaced to the rear for opening up the roof opening 4.

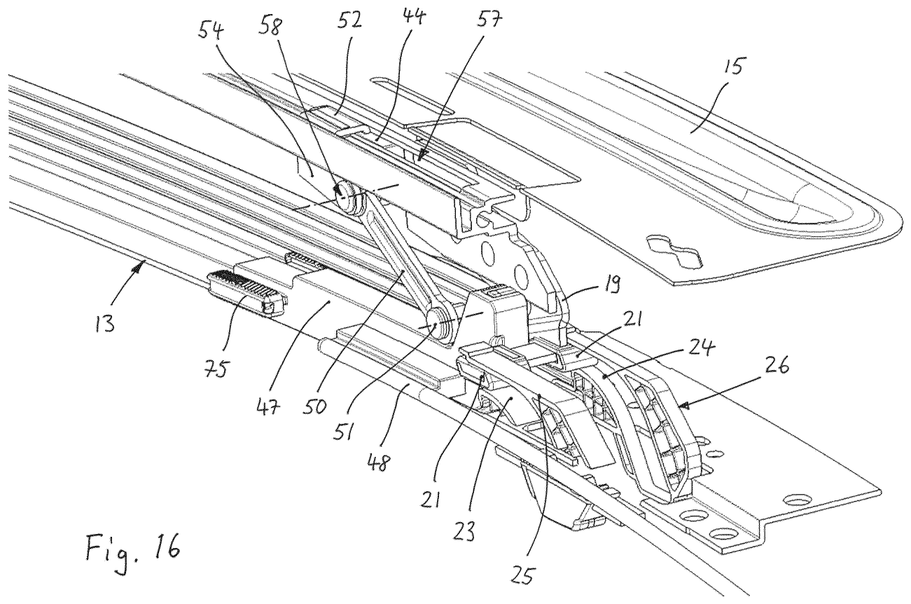

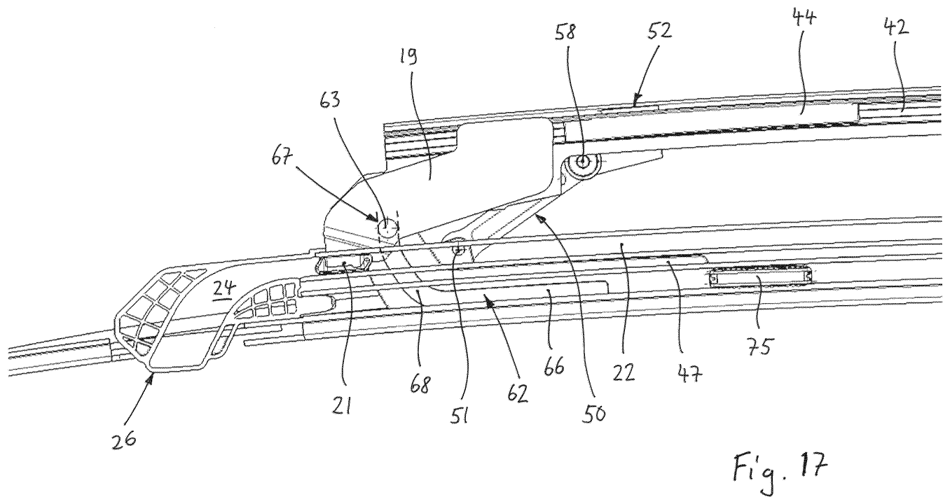

The opening of the cover 3 from its closed position (FIGS. 11 to 13) into an open position (FIGS. 16 to 18) is described hereinafter. In the closed position, the cover 3 is arranged in the roof opening 4 flush with the surrounding roof surface. The slides 21 of the cover support arm 19 are located in the two lifting slotted tracks 23 and 24 in a lower initial position. The drive carriage 47 is located in a front initial position. The control engagement part 63 of the cover support arm 19 is arranged at the rear end of the horizontal portion 66 of the control slotted track 62. The coupling unit 49 holds the control element 42 in a front position by the horizontally oriented coupling link 50. The driver element 52 is located in a front region of the two longitudinal slots 56 and 57. The bearing bush 59 bears against the lower face of the cover rail 18. The control element 42 holds the cover carriage 38 in a front position, whereby the deployment lever 12 of the rear bearing unit 10 is positioned in a front, downwardly pivoted initial position.

The cover 3 is secured in the region of the front bearing unit 8 by the slides 21 in the lifting slotted tracks 23 and 24 and by the rotating slide 64 in the horizontal portion 66 of the control slotted track 62 of the drive carriage 47 against being vertically lifted out of the roof opening 4 and is securely supported and locked in the vertical or z-direction. Moreover, the cover 3 is secured in the region of the rear bearing unit 10 by the front slides 27 of the deployment arm 12, which are positioned on the approximately horizontally running front portion of the two lifting slotted tracks 33 and 34 of the sliding tracks 31 and 32 of the rear guide rail 13, against being vertically lifted from the roof opening 4 and is securely supported and locked in the vertical or z-direction. Both on the front bearing unit 8 and on the rear bearing unit 10, the cover 3 is supported in each case on two guide tracks or sliding tracks or slotted tracks arranged adjacent to one another in the y-direction or transverse direction and thus twice, namely by the support of the slides 21 on the two slide tracks 22 or the two lifting slotted tracks 23 and 24 and the cover carriage 38 via the inner carriage slide 39 and the outer carriage slide 40 on the cover rail 18, or on the additional cover rail 41 and the deployment lever 12 via in each case the inner or outer slides of the front slides 27 and the rear slides 28 on the two sliding tracks 31 and 32 of the rear guide rail 14 and the lifting slotted tracks 33 and 34 thereof.

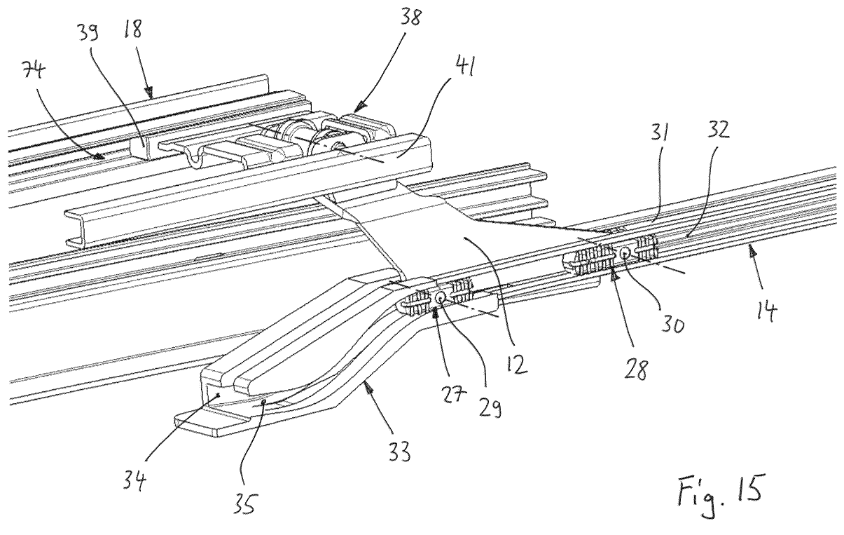

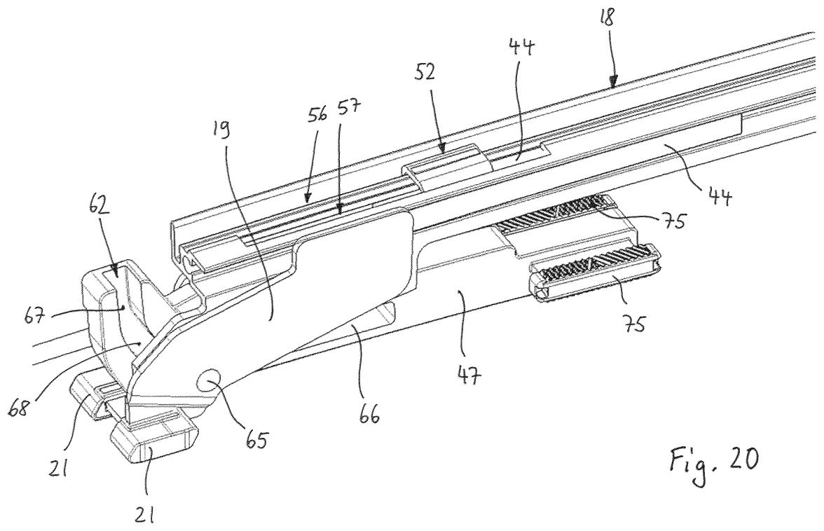

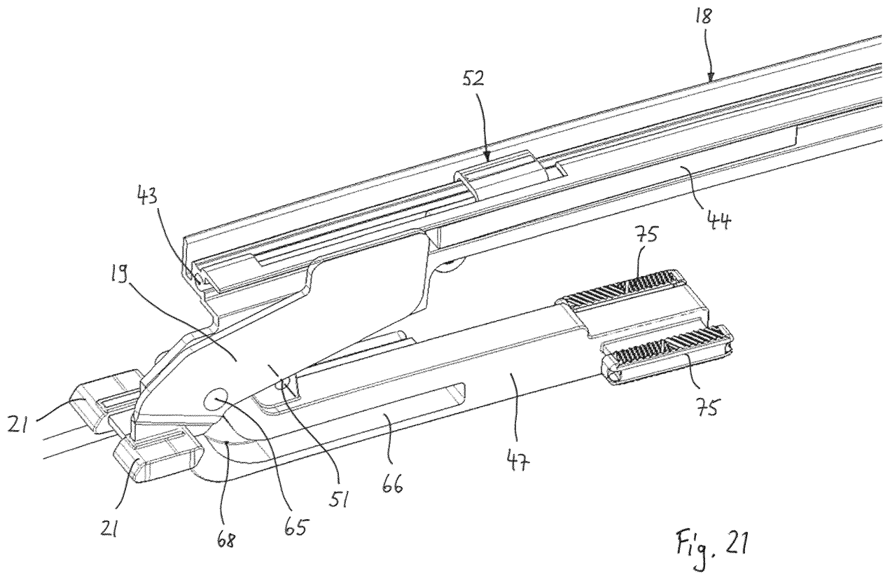

For adjusting the cover 3 from its closed position into a ventilation position with the lifted rear edge 5 (movement from the position of FIGS. 12 and 13 in the direction of the position of FIGS. 14 and 15) the drive carriage 47 is moved via the drive cable 48 along the guide rail 13 in the x-direction or to the rear. The cover 3 does not change its position in the longitudinal or x-direction, since the two slides 21 are prevented from longitudinal displacement in the lifting slotted tracks 23 and 24, and the resting rotating slide 64 in the horizontal portion 66 of the control slotted track 62 moving to the rear can move relative thereto. By means of the coupling unit 49 the drive carriage 47 displaces the control element 42 in its longitudinal guide 43 on the cover rail 18 to the rear relative to the cover 3. The cover carriage 38 moved to the rear by the control element 42 slides with its front slides 27 in the lifting slotted tracks 34 and 35 of the lifting portion 33 upwardly to the level of the sliding tracks 31 and 32 of the rear guide rail 14, whereby the deployment lever 12 with its rearward movement is pivoted upwardly and lifts the cover 3 on its rear edge 5 into a ventilation position. If the drive carriage 47 is displaced further to the rear from the position of FIG. 20, the control engagement part 63 is moved into the transition portion 68 of the control slotted track 62 in which it is successively lifted (FIG. 14). As a result, the two slides 21 of the cover support arm 19 are lifted in the lifting slotted tracks 23 and 24 and displaced to the rear according to the inclination of the lifting slotted tracks 23 and 24, whereby the cover 3 is also slightly displaced to the rear. The control element 42 is fixedly held on the cover rail 18 via the coupling link 50 in a rear end position (FIG. 15).

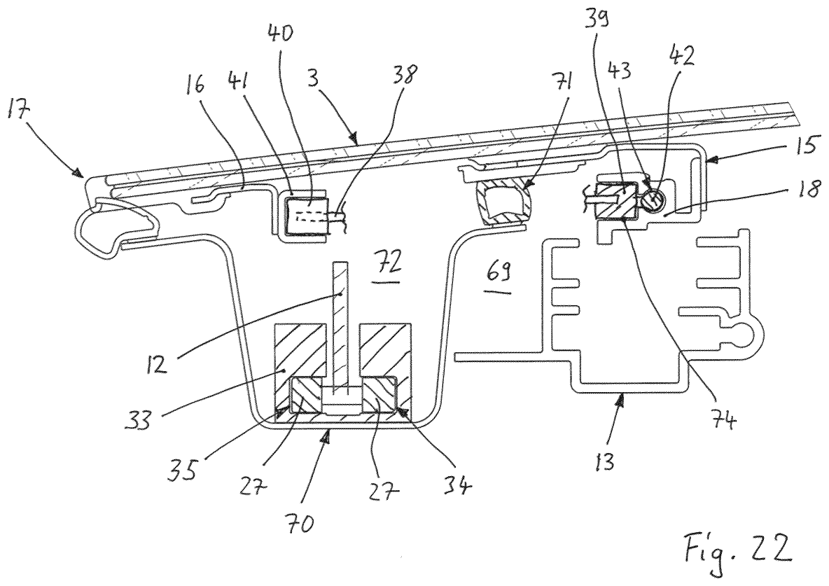

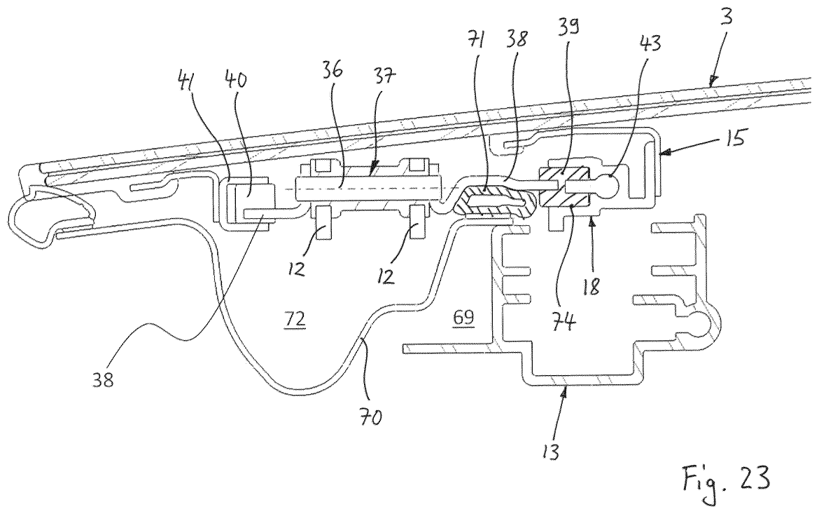

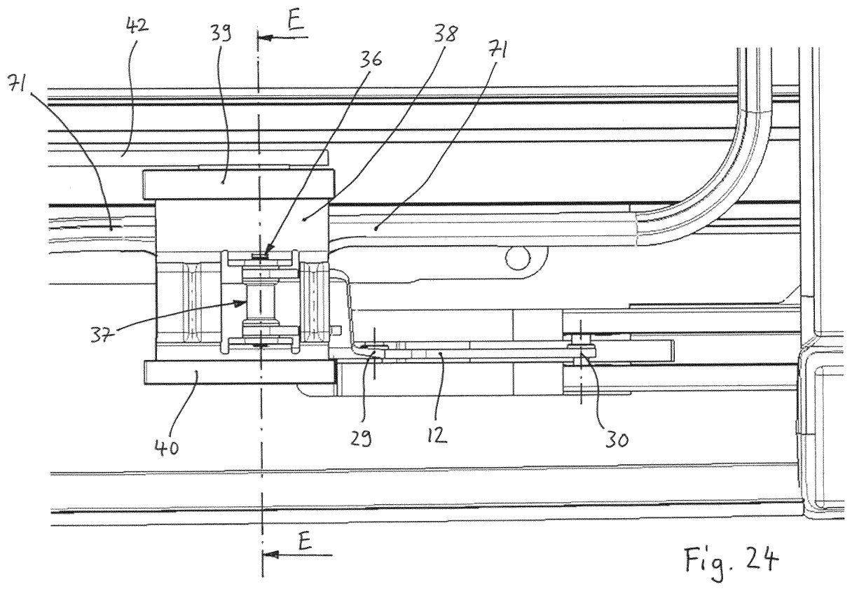

In order to displace the cover 3 to the rear from such a ventilation position into an open position at least partially opening up the roof opening 4, the drive carriage 47 is moved further to the rear. By the cooperation of the slides 21, which are guided in the lifting slotted tracks 23 and 24, and the control engagement part 63 which is moved from the transition portion 68 into the vertical portion 67 of the control slotted track 62 of the drive carriage 47, the cover 3 is displaced in the z-direction into its upper position according to the slides 21 which are lifted to the level of the slide guides 22 (FIGS. 16 and 21). A further movement of the drive carriage 47 in the x-direction, for example into the position shown in FIG. 17, and beyond, via the entrainment of the control engagement part 63 in the vertical portion 67 of the control slotted track 62, brings about a displacement of the cover 3 in the longitudinal or x-direction along the guide rail 13 and a corresponding movement of the deployment lever 12 along the rear guide rail 14 (FIG. 18).

The described movements take place in the opposing movement sequence when closing the cover 3.

In the vehicle roof according to the invention, the safety is improved in the event of a crash or front collision with the cover 3 open, since the coupling unit 49 supports the driver element 52, which strikes against the rear ends of the longitudinal slots 56 and 57, via stable components such as the coupling link 50 and the joints 51 and 58. Thus the cover 3 is supported via the cover rail 18 and the coupling device 49 on the drive carriage 47.

1. A vehicle roof comprising:
a cover closing a roof opening, comprising a bearing device which movably bears the cover by a front bearing unit and by a rear bearing unit on a longitudinal guide, located on the roof side, and adjusts the cover between a closed position in the roof opening and at least one ventilation position deployed upwards on its rear edge, and
comprising a cover adjusting drive which is assigned to the front bearing unit and which actuates the rear bearing unit by a control element,
wherein the control element is longitudinally displaceably mounted on a longitudinal guide arranged on the cover.

2. The vehicle roof as claimed in claim 1, wherein the longitudinal guide, located on the roof side, has a front longitudinal guide with the front bearing unit mounted thereon and a rear longitudinal guide with the rear bearing unit mounted thereon, wherein the front longitudinal guide is arranged in a dry area of a roof frame and the rear longitudinal guide is arranged in a wet area of the roof frame.

3. The vehicle roof as claimed in claim 1, wherein the longitudinal guide, located on the cover side, is formed on a cover rail which is arranged on the cover lower face.

4. The vehicle roof as claimed in claim 3, wherein the cover is mounted on the front longitudinal guide, on the rear longitudinal guide and on the longitudinal guide located on the cover side, in each case via slides on two guide components or guides which are assigned to one another and which are arranged adjacent to one another in the cover transverse direction.

5. The vehicle roof as claimed in claim 1, wherein the cover adjusting drive has a drive carriage which is displaceably mounted on the longitudinal guide, located on the roof side, and is coupled to the control element by a coupling unit.

6. The vehicle roof as claimed in claim 1, wherein the control element is connected at its front end to a control element slide which is displaceably mounted on the cover rail and via which the coupling unit is coupled to the control element.

7. The vehicle roof as claimed in claim 1, wherein the coupling unit has a coupling link which, on the one hand, is pivotably articulated to the drive carriage and, on the other hand, is pivotably connected to a driver element which is fixedly connected to the control element slide.

8. The vehicle roof as claimed in claim 1, wherein the rear bearing unit comprises a deployment lever which is coupled to a cover carriage of the rear bearing unit, wherein the cover carriage is displaceably mounted on a carriage guide, located on the cover side, and is connected to the control element.

9. The vehicle roof as claimed in claim 8, wherein the carriage guide, located on the cover side, has the cover rail and an additional cover rail which is arranged parallel to a rear portion of the cover rail and in that the cover carriage is displaceably mounted on the cover rail and on the additional cover rail on its two opposing longitudinal sides in the cover transverse direction.

10. The vehicle roof as claimed in claim 8, wherein the deployment lever is displaceably mounted on two opposing guide tracks of the carriage guide, located on the roof side, by assigned carriage slides.

11. The vehicle roof as claimed in claim 1, wherein a guide rail of the front longitudinal guide, located on the roof side, has on its front end an inner lifting slotted track and an outer lifting slotted track relative to the cover transverse direction, and
that the front bearing unit has a front cover support arm which is slidably supported by sides, on the two sides, both on the inner lifting slotted track and on the outer lifting slotted track.

12. The vehicle roof as claimed in claim 11, wherein the front cover support arm has a control engagement part which is received in a control slotted track of the drive carriage.

13. The vehicle roof as claimed in claim 8, wherein in the closed position of the cover the drive carriage and the control element coupled thereto are arranged in respective front positions and with an adjustment of the cover into its ventilation position the longitudinally moved drive carriage displaces to the rear the control element and therewith the cover carriage relative to the cover which is fixedly held in the longitudinal direction, wherein the cover carriage over its relative displacement displaces the deployment lever, which is arranged on a front lifting portion of the rear longitudinal guide, located on the roof side, into its deployed position.

14. The vehicle roof as claimed in claim 8, wherein the length of the additional cover rail corresponds to the adjustment path of the cover carriage on the cover.

15. The vehicle roof as claimed in claim 6, wherein the longitudinal guide, located on the cover side, is formed on a cover rail which is arranged on a cover frame or on a cover plate.

16. The vehicle roof as claimed in claim 1, wherein the elongated control element is received so as to be guided in the longitudinal guide over the guide length of the longitudinal guide.

17. The vehicle roof as claimed in claim 1, wherein the longitudinal guide is formed as a guide channel in which the elongated control element is displaceably received.

18. The vehicle roof as claimed in claim 1, wherein the elongated control element is a control rod or a cable which is rigid in terms of tension and compression.
